(19) United States
(12) Patent Application Publication
(10) Pub. No.: US 2007/0291020 A1
(43) Pub. Date: Dec. 20, 2007

(54) MBOOK

(76) Inventors: Yevgeniy N. Grischenko, Brooklyn, NY (US); George Tkachenko-Vishnevetsky, Brooklyn, NY (US)

Correspondence Address: Yevgeniy Grischenko, Apt. 1-J, 2330 Voorhies Avenue, New York, NY, 11235, US

(21) Appl. No.: 11/440,833

(22) Filed: May 25, 2006

(51) Int. Cl. G09G 5/00

(52) U.S. Cl. 345/205; 345/204

(57) ABSTRACT

This is a portable electro-magnetic book (or reusable book frame) device to display digital format files requiring minimal energy. Nothing of this kind is currently available to the public. A user will be able to have single a book like device with almost unlimited source of digital files to display on the device. The effect is achieved by application of electro-magnetic field (electro-magnets) onto permanent magnets, whose ends are black and white accordingly, which form out of themselves viewable symbols (such as letters, punctuation, words, drawings etc.) creating an image of a book page.

The realization of this device will make disposable paper books obsolete.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention pertains to fields of education and publishing.

MBOOK's main purpose is to display text and/or rough drawing in a form of a book without use of paper, printing. Text processor transfers data onto the display to be visualized by a viewer/user/reader. After the data processed onto the display, it doesn't require additional energy to keep the image visible infinite time until it's viewed/read. The data will be provided in multi lingual format.

MBOOK's main purpose is to replace paper disposable books, first of all in field of education. Millions of educational books, text books will become unnecessary to be published, carried around, stored in libraries, homes, universities and public schools, private and public business places. They will be replaced by text format files viewed and read via MBOOK device. Consumption of paper will be reduced dramatically which leads to reduction of wood consumption, which saves forests and shall preserve natural habitat of the planet as whole.

MBOOK will eliminate deficit in the book supply in Public Education System and make P.E. System flexible to innovations and chances in curriculum.

MBOOK will reduce the cost of education by reducing the cost of text books. Students will not need to acquire new expensive paper text books each semester.

MBOOK will save storage space for books, reduce maintenance costs and may lead to elimination or reduction of public libraries, saving resources and monies. Public libraries may be changed from storage of paper books to computer room with an easy access and search of paper books transferred into text format files.

Transition of paper book libraries into MBOOK libraries will allow readers to access any library to receive a book over the internet.

MBOOK will reduce expenses in Publishing sector of economy by reducing consumption of ink and other chemicals used in book publishing. The number and amount of publishing business will be reduced saving space, natural resources: metals, wood, etc.

MBOOK leads to reduction of overall garbage, saving expenses, space etc.

MBOOK has health benefits. Viewers/users/readers of MBOOK display will be able to enlarge fonts to preserve their eyesight. The display does not eliminate any radiation as computer monitors do and does not have any negative effects on a human sight.

MBOOK will save energy because the device needs a small amount of energy when used in comparison with a personal computer.

The device translates digital information into visible and recognizable readable information. No information, references or specific documents related to the invention are found.

### BRIEF SUMMARY OF THE INVENTION

MBOOK's main purpose is to display text and/or rough drawing in a form of a book without use of paper, printing.

MBOOK's main purpose is to replace paper disposable books, saves storage space, reduce maintenance costs, save forest and reduce garbage.

Objective of the invention is to provide educational materials at lower cost, eliminate deficit of educational materials and make curriculum material flexible to innovations and changes. Digitally stored files will replace paper books; a small digital storage drive can hold an entire library eliminating wear and tear problem of paper books; maintenance costs of a library of digital storage drives is minimal compare to paper book. It uses minimal energy compare to computer.

### DETAILED DESCRIPTION OF THE INVENTION

MBOOK is a device which consists of 2 parts:
1) the motherboard with electromagnets powered by a battery via the connection layout with the display (consisted of magnetic bids);
2) the text processor.

MBOOK main purpose is to display texts and rough drawings.

The device is based on the electro-magnetic property of metals.

The device includes a housing with one see through side made of durable transparent material and motherboard mounted inside. The motherboard includes the layout and has mounted parts which are mounted rigidly on it and make up the display. The display could consist of one single part or a set of individually coupled elements: electromagnet and permanent magnet (bid) magnetically isolated.

Each element has controlled terminals from the text processor. The electromagnets control orientation (position/arrangements) of permanent magnets (bids) in the display in order to create visualization (image). A person is able to visualize an image of a book page.

The display includes plurality of the elements, making up a mathematical 2 dimensional matrix for the text processor to parse the data. Each bid is a permanent magnet painted black and white.

The display changes when direct current generates a magnetic field which depends on the currents' direction. The permanent magnet (bid) in that field is forced to position itself in accord with magnetic fields.

The display is a matrix. It consists of bids (the size about 1 mm or less (lesser brings better legibility/contrast) with permanent magnets inside. It sits on top of the motherboard.

The text processor reads the digital data from a file of any text format (or native to this device format) from a USB drive (or similar device), interprets the data to an electric signal (direct current plus or minus); as a result bids turn in a certain way creating an image out of black and white sides. The text processor breaks the display up to rows and columns virtually.

Depending on a font size, the text processor calculates the amount of characters to be displayed and a number of pages in a file accordingly. Knowing a number of pages a user can navigate through the file-book.

The text processor has 3 navigation buttons: next, previous and goto # page. The text processor is able to memorize specified pages. The text processor calculates required number of characters to be transferred onto the display device as a page of a book. A possible number of characters depends on display size and a chosen font size. For example font 1 can take 20 bids (5×4 matrix) and font 2 take 30 bids (6×5 matrix).

Change of direct current + or − forces bids to turn accordingly, displaying either white or black sides, creating visualization. When an image appears it can be displayed indefinitely: the bids are fixed in a permanent position to secure the image. By pressing next, previous or goto button the processor translates a requested page to the display device and fixes it there to be visualized.

MBOOK requires minimal amount of energy to be used in order to maintain its operation.

A user of a MBOOK device inserts a removable drive into the device and is able to read and view the content of the file. The device through its recognition system (text processor) reads the digital format file and transfers it onto the display to be viewed/read by the user. MBOOK is a portable device. The closest device which performs similar task is a portable computer with a monitor.

The main distinction of the MBOOK from a portable computer w/monitor, which is able to display digital files, is low power (energy) consumption. The device doesn't require uninterrupted source of energy to be supplied to the device. Once a page is formed it can stay on without additional energy for infinite time. MBOOK doesn't require additional software and as result is easier in using.

1. It is claimed that MBOOK is an electric portable device which represents data in a new convenient way and to be used as a book substitute to display and process digitally stored information in effective, low energy consumption way.

2. It is claimed a new invention—Electro magnetic display.
